(19) United States
(12) Patent Application Publication
(10) Pub. No.: US 2025/0356122 A1
(43) Pub. Date: Nov. 20, 2025

(54) ARTIFICIAL INTELLIGENCE BASED EVENT GENERATION METHOD AND SYSTEM FOR GENERATING MEMOIR EVENTS BASED ON INFORMATION ASSOCIATED WITH USERS

(71) Applicant: Srirajasekhar Koritala, Naperville, IL (US)

(72) Inventor: Srirajasekhar Koritala, Naperville, IL (US)

(21) Appl. No.: 18/668,357

(22) Filed: May 20, 2024

(51) Int. Cl. G06F 40/284; G06F 40/30

(52) U.S. Cl. CPC G06F 40/284; G06F 40/30

(57) ABSTRACT

An AI-based event generation method and system for generating memoir events based on information associated with users is disclosed. The AI-based event generation method includes obtaining inputs from electronic devices associated with users; tokenizing information related to the users, to convert the information into first tokens being analyzed by an AI-model, using tokenization process; converting each token into embeddings; assigning weights to each token to determine relationships between first tokens, upon analyzing importance of the first tokens in sequences of inputs based on the embeddings being processed at neural network architecture; generating second tokens based on weights assigned to each token of first tokens, by determining subsequent tokens associated with the second tokens based on the first and second tokens using probability distribution applied on vocabularies of second tokens; generating the memoir events by concatenating second tokens; and providing an output of generated memoir events on user interface.

### TECHNICAL FIELD

Embodiments of the present disclosure relate to memoir creation systems and more particularly relate to an artificial intelligence based (AI-based) event generation system and method for generating one or more memoir events based on one or more information associated with one or more users.

### BACKGROUND

Memoirs are autobiographical accounts that provide a glimpse into personal experiences, reflections, and insights of individuals. These narratives capture significant moments, emotions, and challenges encountered throughout a life of the individuals, providing readers with a deeper understanding of a journey of the individuals. The memoirs explore themes of identity, growth, resilience, and human connection, resonating with audiences through their authenticity and relatability. By sharing stories, the individuals not only preserve legacies but also provide valuable lessons and perspectives that inspire, inform, and enrich the lives of the readers. Traditionally, a process of creating the memoir has been labor-intensive and time-consuming, requiring significant effort in writing, editing, and organizing content.

With an advent of digital technologies, there has been a growing interest in leveraging artificial intelligence (AI) and machine learning techniques to automate and streamline the process of the memoir-writing. The AI and machine learning technologies provide the potential to enhance an accuracy, efficiency, and personalization of the memoir creation, making the memoir more accessible to a wider audience. Existing digital memoir platforms and tools provide basic features for capturing and organizing user-generated content, including text, images, videos, and the like. However, the existing digital memoir platforms lack advanced AI capabilities for editing, correcting, and suggesting improvements to the content of the memoir, as well as integrating one or more multi-media contents seamlessly.

In the existing technology, an autobiographical contents-specialized platform service provision system based on social network service is disclosed. The system includes a keyword identification unit tasked with determining if the user-generated content includes keywords stored in a database, followed by a content structuring and grouping unit that organizes the content according to the user preferences. A display unit presents the structured content to one or more users, while a knowledge link service unit facilitates the extraction of significant events related to a birth date of the one or more users and connects the one or more users with experts relevant to the autobiographical content. Furthermore, a digital genealogy service unit creates kinship representations based on a surname and relative information of the one or more users. Additionally, a publishing service unit manages requests for quotations from professional publishing agencies, displays quotations, and coordinates the publication of the autobiographical content. Lastly, a sharing and sales service unit enables the one or more users to distribute, share, or monetize the autobiographical content with the other one or more users or third parties. Nevertheless, the system includes features including the keyword identification and the content structuring, hence the system provides limited personalization options. The system is primarily focused on the autobiographical content creation and publication and fails to provide a broader range of functionalities, including voice recording and the multi-media content integration.

There are various technical problems with the existing digital memoir platforms in the prior art. In the existing technology, the existing digital memoir platforms lack advanced features for the personalization and customization. Many existing digital memoir platforms may not incorporate the AI-driven editing, correction, and suggestion features, leaving the individuals to manually review and revise the content for grammar, style, and coherence. While some digital memoir platforms support basic one or more multi-media contents including text and images, but the digital memoir platforms lack advanced capabilities for integrating audio, video, and other interactive elements into the memoirs. The existing digital memoir platforms may not provide mechanisms for updating the memoirs over time or incorporating new experiences and the memories as they occur.

Therefore, there is a need for an artificial intelligence based (AI-based) event generation system and method for generating one or more memoir events based on one or more information associated with one or more users, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) event generation method for generating one or more memoir events based on one or more information associated with one or more users is disclosed.

The AI-based event generation method includes obtaining, by one or more hardware processors, one or more inputs from one or more electronic devices associated with the one or more users. The one or more inputs comprise the one or more information related to the one or more users. The one or more information is associated with at least one of: one or more prompts, and life and experiences associated with the one or more users. The AI-based event generation method further includes tokenizing, by the one or more hardware processors, the one or more information related to the one or more users, to convert the one or more information into one or more first tokens being analyzed by an artificial intelligence (AI) model, using a tokenization process. The one or more first tokens comprise at least one of: one or more words, one or more sub-words, and one or more characters, based on the tokenization process.

The AI-based event generation method further includes converting, by the one or more hardware processors, each token into one or more embeddings. The one or more embeddings are one or more numerical representations comprising at least one of: one or more semantic and syntactic information associated with the one or more first tokens. The AI-based event generation method further includes assigning, by the one or more hardware processors, one or more weights to each token to determine one or more relationships between the one or more first tokens, upon analyzing an importance of the one or more first tokens in one or more sequences of the one or more inputs based on the one or more embeddings being processed at a neural network architecture of the AI model.

The AI-based event generation method further includes generating, by the one or more hardware processors, one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens. The one or more second tokens are generated until the AI model generates a predetermined optimum length of one or more sequences of the one or more second tokens.

The AI-based event generation method further includes generating, by the one or more hardware processors, the one or more memoir events by concatenating the one or more second tokens. Subsequently, the AI-based event generation method further includes providing, by the one or more hardware processors, an output of the generated one or more memoir events on a user interface associated with the one or more electronic devices of the one or more users.

In an embodiment, the AI-based event generation method further comprises training, by the one or more hardware processors, the AI model. The training of the AI model includes obtaining, by the one or more hardware processors, one or more data from one or more data sources comprising at least one of: one or more books, one or more articles, and one or more websites. The training of the AI model further includes tokenizing, by the one or more hardware processors, one or more data to convert the one or more data into one or more third tokens, wherein the one or more third tokens comprise the one or more words, one or more parts of words, and one or more individual characters.

The training of the AI model further includes training, by the one or more hardware processors, the AI model on the obtained one or more data using a supervised learning algorithm. Training the AI model comprises learning of the AI model to at least one of: determine at least one of: the one or more second tokens in the one or more sequences and provide the missing one or more second tokens in the one or more sequences. The training of the AI model further includes fine-tuning, by the one or more hardware processors, the trained AI model on one or more task-specific datasets to optimize performance of the AI model on one or more applications. The training of the AI model further includes evaluating, by the one or more hardware processors, the trained AI model to assess capabilities of the AI model in analyzing and generation of the one or more memoir events.

In another embodiment, the trained artificial intelligence (AI) model on the one or more task-specific datasets is fine-tuned using at least one of: beam search and reinforcement learning, based on a feedback on the performance of the artificial intelligence (AI) model.

In yet another embodiment, the AI-based event generation method further includes: (a) obtaining, by the one or more hardware processors, one or more voice based inputs from the one or more electronic devices associated with the one or more users, (b) determining, by the one or more hardware processors, an optimized voice cloning based artificial intelligence model among one or more voice cloning based artificial intelligence models upon analyzing one or more cloned voices being identical to one or more voices associated with the one or more users, (c) extracting, by the one or more hardware processors, at least one of: emotions and accents, associated with the one or more voice based inputs of the one or more users, using the optimized voice cloning based artificial intelligence model, (d) applying, by the one or more hardware processors, at least one of: the emotions and accents into a base speech model, and (e) generating, by the one or more hardware processors, the one or more cloned voices being identical to one or more voices associated with the one or more users by applying one or more speech artifacts with the base speech model.

In yet another embodiment, the AI-based event generation method further includes: (a) obtaining, by the one or more hardware processors, the one or more inputs from the one or more electronic devices associated with the one or more users, wherein the one or more inputs comprise one or more events occurred during the life and experiences associated with the one or more users, (b) retrieving, by the one or more hardware processors, information associated with the one or more events occurred during the life and experiences based on training of the AI model on the one or more data sources, and (c) providing, by the one or more hardware processors, the information associated with the one or more events occurred during the life and experiences, to the one or more electronic devices associated with the one or more users to adapt the one or more users to select the information associated with the one or more events.

In yet another embodiment, the AI-based event generation method further includes: (a) obtaining, by the one or more hardware processors, one or more multi-media contents comprising one or more videos, one or more images, one or more audios, associated with the life and experiences of the one or more users, from the one or more electronic devices associated with the one or more users, (b) analyzing, by the one or more hardware processors, the one or more multi-media contents to extract one or more emotional parameters associated with the one or more users, wherein the one or more emotional parameters comprise at least one of: sentiment, happy, and sad, associated with the one or more users, and (c) integrating, by the one or more hardware processors, the one or more emotional parameters associated with the one or more users, into the one or more memoir events to optimize the one or more memoir events.

In yet another embodiment, the AI-based event generation method further includes combining, by the one or more hardware processors, the one or more cloned voices with one or more cloned images of the one or more users to generate a virtual reality displaying that the one or more cloned images of the one or more users read the one or more memoir events in the one or more cloned voices of the one or more users, using one or more virtual reality based technologies.

In one aspect, an AI-based event generation system for generating the one or more memoir events based on the one or more information associated with the one or more users is disclosed. The AI-based event generation system comprises the one or more hardware processors and a memory. The memory is coupled to the one or more hardware processors. The memory comprises a plurality of subsystems in form of programmable instructions executable by the one or more hardware processors.

The plurality of subsystems comprises an input obtaining subsystem, a token generation subsystem, an embedding conversion subsystem, a weight assigning subsystem, an event generation subsystem, a training subsystem, a voice cloning subsystem, an event optimizing subsystem, a virtual reality subsystem, and an output subsystem.

In an embodiment, the input obtaining subsystem is configured to receive the one or more inputs from the one or more electronic devices associated with the one or more users. The one or more inputs comprise the one or more information related to the one or more users. The one or more information is associated with at least one of the: one or more prompts, and life and experiences associated with the one or more users. The token generation subsystem is configured to tokenize the one or more information related to the one or more users, to convert the one or more information into the one or more first tokens being analyzed by the AI model, using a tokenization process. The one or more first tokens comprise at least one of: one or more words, one or more sub-words, and one or more characters, based on the tokenization process.

The embedding conversion subsystem is configured to convert each token into the one or more embeddings. The one or more embeddings are the one or more numerical representations comprising at least one of: one or more semantic and syntactic information associated with the one or more first tokens. The weight assigning subsystem is configured to assign one or more weights to each token to determine one or more relationships between the one or more first tokens, upon analyzing an importance of the one or more first tokens in the one or more sequences of the one or more inputs using the neural network architecture of the AI model.

The token generation subsystem is further configured to generate the one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens. The one or more second tokens are generated until the AI model generates a predetermined optimum length of the one or more sequences of the one or more second tokens.

The event generation subsystem is configured to generate the one or more memoir events by concatenating the one or more second tokens. The output subsystem is configured to provide an output of the generated one or more memoir events on the user interface associated with the one or more electronic devices of the one or more users.

In an embodiment, the AI-based event generation system further comprises the training subsystem that is configured to train the AI model. The training subsystem is configured to: (a) obtain one or more data from one or more data sources comprising at least one of: one or more books, one or more articles, and one or more websites, (b) tokenize one or more data to convert the one or more data into the one or more third tokens, wherein the one or more third tokens comprise the one or more words, one or more parts of words, and one or more individual characters, (c) train the AI model on the obtained one or more data using a supervised learning algorithm. Training the AI model comprises learning of the AI model to at least one of: determine at least one of: the one or more second tokens in the one or more sequences and provide the missing one or more second tokens in the one or more sequences, (d) fine-tune the trained AI model on one or more task-specific datasets to optimize performance of the AI model on one or more applications, and (e) evaluate the trained AI model to assess capabilities of the AI model in analyzing and generation of the one or more memoir events.

In another embodiment, the AI-based event generation system further comprises the voice cloning subsystem that is configured to: (a) obtain the one or more voice based inputs from the one or more electronic devices associated with the one or more users, (b) determine an optimized voice cloning based artificial intelligence model among one or more voice cloning based artificial intelligence models upon analyzing the one or more cloned voices being identical to one or more voices associated with the one or more users, (c) extract at least one of: emotions and accents, associated with the one or more voice based inputs of the one or more users, using the optimized voice cloning based artificial intelligence model, (d) apply at least one of: the emotions and accents into a base speech model, and (e) generate the one or more cloned voices being identical to one or more voices associated with the one or more users by applying one or more speech artifacts with the base speech model.

In yet another embodiment, the event generation subsystem is further configured to: (a) obtain the one or more inputs from the one or more electronic devices associated with the one or more users. The one or more inputs comprise one or more events occurred during the life and experiences associated with the one or more users, (b) retrieve the information associated with the one or more events occurred during the life and experiences based on training of the AI model on the one or more data sources, and (c) provide the information associated with the one or more events occurred during the life and experiences, to the one or more electronic devices associated with the one or more users to adapt the one or more users to select the information associated with the one or more events.

In yet another embodiment, the AI-based event generation system further comprises the event optimizing subsystem that is configured to: (a) obtain one or more multi-media contents comprising one or more videos, one or more images, one or more audios, associated with the life and experiences of the one or more users, from the one or more electronic devices associated with the one or more users, (b) analyze the one or more multi-media contents to extract one or more emotional parameters associated with the one or more users. The one or more emotional parameters comprise at least one of: sentiment, happy, and sad, associated with the one or more users, and (c) integrate the one or more emotional parameters associated with the one or more users, into the one or more memoir events to optimize the one or more memoir events.

In yet another embodiment, the AI-based event generation system further comprises the virtual reality subsystem that is configured to combine the one or more cloned voices with the one or more cloned images of the one or more users to generate a virtual reality displaying that the one or more cloned images of the one or more users read the one or more memoir events in the one or more cloned voices of the one or more users, using one or more virtual reality based technologies.

In another aspect, a non-transitory computer-readable storage medium having instructions stored therein that, when executed by the one or more hardware processors, causes the one or more hardware processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram illustrating a computing environment with an artificial intelligence based (AI-based) event generation system for generating one or more memoir events based on one or more information associated with one or more users, in accordance with an embodiment of the present disclosure;

FIG. 2 illustrates a detailed view of the AI-based event generation system for generating the one or more memoir events based on the one or more information associated with the one or more users, such as those shown in FIG. 1, in accordance with an embodiment of the present disclosure; and

FIG. 3 illustrates a flow chart depicting an AI-based event generation method for generating the one or more memoir events based on the one or more information associated with the one or more users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

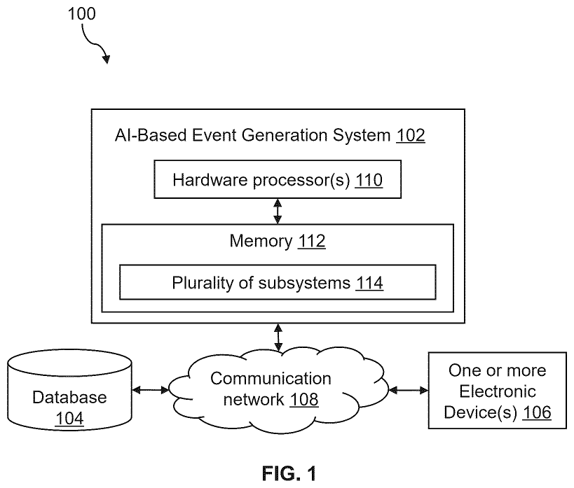

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates an exemplary block diagram illustrating a computing environment 100 with an artificial intelligence based (AI-based) event generation system 102 for generating one or more memoir events based on one or more information associated with one or more users, in accordance with an embodiment of the present disclosure.

According to an exemplary embodiment of the present disclosure, FIG. 1 depicts the computing environment 100 that may include the AI-based event generation system 102 (hereinafter referred to as the system 102), a database 104, and one or more electronic devices 106. The system 102 may be communicatively coupled to the database 104, and the one or more electronic devices 106 via a communication network 108. The communication network 108 may be a wired communication network and/or a wireless communication network. The database 104 may include, but not limited to, storing, managing, and organizing data related to various aspects of an operation of the system 102. The data may comprise, but not limited to, one or more inputs, the one or more memoir events, and other relevant data necessary for a functionality of the system 102. The database 104 may be any kind of database such as, but not limited to, relational databases, non-relational databases, graph databases, document databases, dedicated databases, dynamic databases, monetized databases, scalable databases, cloud databases, distributed databases, any other databases, and a combination thereof. The database 104 is configured to support the functionality of the system 102 and enables efficient data retrieval and storage for various aspects associated with the one or more memoir events.

In an exemplary embodiment, the one or more electronic devices 106 may include, but not limited to, a mobile device, a smartphone, a Personal Digital Assistant (PDA), a tablet computer, a phablet computer, and the like.

The computing environment 100 facilitates seamless communication and data exchange, enabling the system 102 to operate cohesively for generating the one or more memoir events. The capability of the system 102 to generate the one or more memoir events is underpinned by effective collaboration among the system 102, the database 104, and the one or more electronic devices 106 within the communication network 108.

Further, the system 102 may be implemented by way of a single device or a combination of multiple devices that may be operatively connected or networked together. The system 102 may be implemented in hardware or a suitable combination of hardware and software. The system 102 includes one or more hardware processors 110, and a memory 112. The memory 112 may include a plurality of subsystems 114. The system 102 may be a hardware device including the one or more hardware processors 110 executing machine-readable program instructions for generating the one or more memoir events. Execution of the machine-readable program instructions by the one or more hardware processors 110 may enable the system 102 to dynamically recommend a course of action sequence for generating the one or more memoir events. The course of action sequences may involve various steps or decisions taken for input obtaining, token generating, embedding conversion, weight assigning, event generating, voice cloning, and event optimizing. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

The system 102 is initially configured to obtain one or more inputs from one or more electronic devices 106 associated with the one or more users. The one or more inputs comprise the one or more information related to the one or more users. The one or more information is associated with at least one of: one or more prompts, and life and experiences associated with the one or more users. The system 102 is further configured to tokenize the one or more information related to the one or more users, to convert the one or more information into one or more first tokens being analyzed by an artificial intelligence (AI) model, using a tokenization process. The one or more first tokens may include at least one of: one or more words, one or more sub-words, and one or more characters, based on the tokenization process.

The system 102 is further configured to convert each token into one or more embeddings. In an embodiment, the one or more embeddings are one or more numerical representations including at least one of: one or more semantic and syntactic information associated with the one or more first tokens. The system 102 is further configured to assign one or more weights to each token to determine one or more relationships between the one or more first tokens, upon analyzing an importance of the one or more first tokens in one or more sequences of the one or more inputs based on the one or more embeddings being processed at a neural network architecture of the artificial intelligence (AI) model.

The system 102 is further configured to generate one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens. In an embodiment, the one or more second tokens are generated until the artificial intelligence (AI) model generates a predetermined optimum length of one or more sequences of the one or more second tokens.

The system 102 is further configured to generate the one or more memoir events by concatenating the one or more second tokens. The system 102 is further configured to provide an output of the generated one or more memoir events on a user interface associated with the one or more electronic devices 106 of the one or more users.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. A person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

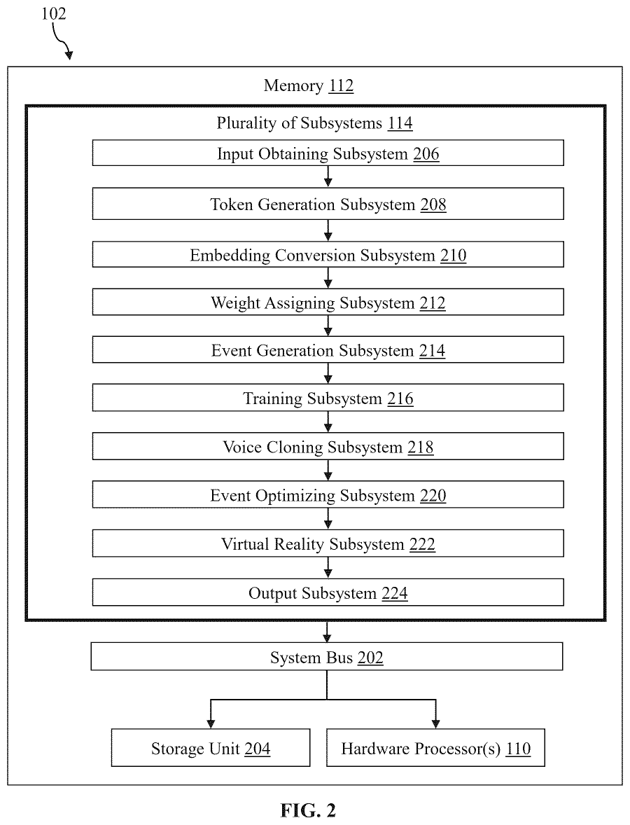

FIG. 2 illustrates a detailed view of the system 102 for generating the one or more memoir events based on the one or more information associated with the one or more users, such as those shown in FIG. 1, in accordance with an embodiment of the present disclosure.

In an exemplary embodiment, the system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 is operatively coupled to the one or more hardware processors 110. The memory 112 comprises the plurality of subsystems 114 in the form of programmable instructions executable by the one or more hardware processors 110.

In an exemplary embodiment, the plurality of subsystems 114 comprises an input obtaining subsystem 206, a token generation subsystem 208, an embedding conversion subsystem 210, a weight assigning subsystem 212, an event generation subsystem 214, a training subsystem 216, a voice cloning subsystem 218, an event optimizing subsystem 220, a virtual reality subsystem 222, and an output subsystem 224.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of subsystems 114 stored in the form of machine-readable instructions on any of the above-mentioned storage media and may be in communication with and executed by the one or more hardware processors 110.

The storage unit 204 may be a cloud storage or the database 104 such as those shown in FIG. 1. The storage unit 204 may store, but not limited to, recommending a course of action sequences, applications, application links, application name, application description, application meta-data, application identifier, display names of the one or more applications, short textual description, a universal resource locator (URL) of the one or more applications, and a list of parameters corresponding to an application context, generated recommending course of action sequences, one or more clickable elements, completion status of initiated user action through recommended course of action sequences, feedback loops, feedback from the one or more users, query parameters, additional query parameters, deep integration parameters, up-sell/x-sell product links, tracked user click-through rates, any other data, and combinations thereof. The storage unit 204 may be any kind of the database 104 such as, but not limited to, relational databases, dedicated databases, dynamic databases, monetized databases, scalable databases, cloud databases, distributed databases, any other databases, and a combination thereof.

The plurality of subsystems 114 includes the input obtaining subsystem 206 that is communicatively connected to the one or more hardware processors 110. The input obtaining subsystem 206 is configured to obtain the one or more inputs from the one or more electronic devices 106 of the one or more users. The one or more inputs is obtained through the communication network 108. The one or more inputs encompasses the one or more information pertinent to the one or more users. The one or more information may comprise, but not limited to, at least one of: the one or more prompts, life and experiences, and the like, associated with the one or more users. The input obtaining subsystem 206 ensures a comprehensive understanding of backgrounds and contexts of the one or more users. The acquired one or more inputs serves as the foundation for subsequent processes within the system 102, facilitating the generation of the one or more personalized memoir events tailored to unique experiences and preferences of the one or more users.

In another exemplary embodiment, the system 102 employs an artificial intelligence (AI) model that is trained to handle various aspects of text processing, including grammar, structure, spelling, and the like. The AI model undergoes a series of transformations to enhance the quality and accuracy of the one or more inputs. Through an Application Programming Interface (API), the system 102 invokes the AI model, which then processes one or more input texts and returns the transformed and refined one or more input texts to the system 102 via the API. The system 102 is designed with a flexible architecture, allowing seamlessly replacing the existing AI model with at least one of: the more advanced AI model and retrain and fine-tune the current AI model continuously. This approach empowers the system 102 to continually enhance capabilities and deliver improved performance in text processing tasks.

The plurality of subsystems 114 includes the token generation subsystem 208 that is communicatively connected to the one or more hardware processors 110. The token generation subsystem 208 undertakes a task of tokenizing the one or more information associated with the one or more users. The token generation subsystem 208 is configured to convert the one or more information into the one or more first tokens that are then analyzed by the AI model. The one or more first tokens encompasses various elements that may comprise, but not limited to, at least one of: one or more words, one or more sub-words, one or more characters, and the like, based on the tokenization process. By breaking down the one or more information into the one or more first tokens, the token generation subsystem 208 enables the AI model to effectively process and analyze the one or more information, laying the groundwork for the subsequent stages for generation of the one or more memoir events tailored to the experiences and the preferences of the one or more users.

The plurality of subsystems 114 includes the embedding conversion subsystem 210 that is communicatively connected to the one or more hardware processors 110. The embedding conversion subsystem 210 is configured to transform each token into the one or more embeddings. The one or more embeddings represent the one or more numerical representations encapsulating at least one of, but not limited to, semantic information, syntactic information, and the like, linked to the respective one or more first tokens. By converting the one or more first tokens into the one or more embeddings, the system 102 facilitates the transformation of textual data into a format that the AI model effectively analyzes and interprets.

The plurality of subsystems 114 includes the weight assigning subsystem 212 that is communicatively connected to the one or more hardware processors 110. The weight assigning subsystem 212 is configured to assign the one or more weights to each first token to determine the one or more relationships between the one or more first tokens derived from the one or more inputs. By employing a neural network architecture of the AI model, the weight assigning subsystem 212 is configured to analyze an importance of each first token within the one or more sequences of the one or more inputs based on the one or more embeddings. The one or more weights serves to elucidate the relative importance or relevance of the individual first token of the one or more first tokens within the context of the one or more sequences. By considering the one or more embeddings, the weight assigning subsystem 212 is configured to determine the significance of each first token in the one or more sequences. The neural network architecture may comprise, but not limited to, a transformer.

The plurality of subsystems 114 includes the token generation subsystem 208 that is communicatively connected to the one or more hardware processors 110. The token generation subsystem 208 extends its functionality to generate the one or more second tokens based on the one or more assigned weights of each first token. This process involves determining one or more subsequent tokens associated with the one or more second tokens, considering factors that may comprise, but not limited to, at least one of: the existing one or more first tokens, the one or more second tokens, and the like by employing probability distribution applied on vocabularies of the one or more second tokens. The generation of the one or more second tokens continues iteratively until the AI model generates a predetermined optimum length of one or more sequences of the one or more second tokens. By iteratively generating the one or more second tokens based on the one or more assigned weights and the probability distribution, the system 102 ensures the creation of the coherent and contextually relevant one or more sequences of the one or more second tokens that capture the essence of the one or more inputs.

The plurality of subsystems 114 includes the event generation subsystem 214 that is communicatively connected to the one or more hardware processors 110. The event generation subsystem 214 is configured to generate the one or more memoir events by concatenating the one or more second tokens produced by the token generation subsystem 208. By concatenating the one or more second tokens, the event generation subsystem 214 is configured to generate the one or more coherent memoir events based on the weighted importance of the one or more first tokens Following this, the output subsystem 224 is configured to provide the output of the generated one or more memoir events on the user interface linked to the one or more electronic devices 106 of the one or more users. Subsequently, the output subsystem 224 delivers the generated one or more memoir events, thereby allowing the one or more users to engage with and consume the personalized content conveniently on the one or more electronic devices 106. The output may undergo additional post-processing steps, including grammar correction, coherence enhancement, adherence, and the like to specific response formats.

Herein in another exemplary embodiment, the generated output may undergo further refinement through techniques that may comprise, but not limited to, beam search. The beam search explores various potential one or more sequences other than the one or more inputs to discover a more optimal response and reinforcement learning, which adjusts the AI model based on received feedback. The refinement enhances the quality and relevance of the output. This assists in generating more coherent and contextually relevant textual data by considering different possibilities and selecting the one or more sequences that best fit the context.

The plurality of subsystems 114 further includes the training subsystem 216 that is communicatively connected to the one or more hardware processors 110. The training subsystem 216 is dedicated to refining the capabilities of the AI model. The training subsystem 216 undergoes a comprehensive process designed to enhance the performance of the AI model. Initially, the training subsystem 216 is configured to obtain one or more data from one or more data sources. The one or more data may comprise, but not limited to, at least one of: text, content, transcriptions, posts, and the like. The one or more data sources may comprise, but not limited to, at least one of: one or more books, one or more articles, one or more websites, and the like, followed by tokenizing the one or more data into one or more third tokens. The one or more third tokens may comprise, but not limited to, at least one of: the one or more words, one or more parts of words, one or more individual characters, and the like. Subsequently, the training subsystem 216 is configured to train the AI model on the obtained one or more data using a supervised learning algorithm. The supervised learning algorithm is a machine learning procedure where the supervised learning algorithm learns from labeled data, meaning the supervised learning algorithm is provided with input-output pairs to learn the mapping between the one or more inputs and the corresponding output.

Training the AI model comprises learning of the AI model by determining at least one of: the one or more second tokens in the one or more sequences, provide the missing one or more second tokens in the one or more sequences, and the like. Furthermore, the trained subsystem 216 is configured to fine-tune the trained artificial intelligence (AI) model on one or more task-specific datasets to optimize performance of the AI model on one or more applications. For instance, in sentiment analysis, the AI model may be fine-tuned on the dataset of the one or more task-specific datasets comprising user reviews to better understand and classify sentiments. Similarly, for chatbot development, the AI model is fine-tuned on conversational data to improve the ability to generate contextually relevant and natural responses to user queries. By fine-tuning on the one or more task-specific datasets, the trained subsystem 216 enhances the adaptability and effectiveness of the AI across various applications, ultimately leading to a more accurate and valuable outcome.

Lastly, the training subsystem 216 is configured to evaluate the trained AI model to assess the proficiency of the AI model in analyzing and generating the one or more memoir events, ensuring its efficacy and reliability. In an embodiment, the artificial intelligence (AI) model may include at least one of: Large Language model, Deep Learning model, Random Forest model, Decision-making model, Linear Regression model, Natural Language Processing (NLP) model, and the like.

Through the training subsystem 216, the system 102 iteratively refines the capabilities of the AI model, culminating in the improved performance and the accuracy. This rigorous training and evaluation process underpins the ability of the system 102 to deliver high-quality, tailored content, enhancing user satisfaction and engagement with the generated one or more memoir events. Once trained, the AI model generates human-like text, responses to the user queries, and engages in conversations on a wide range of topics.

In another exemplary embodiment, to generate the one or more memoir events, other models that may comprise, but not limited to, at least one of: Llama2, Palm, and the like are employed within the system 102.

The plurality of subsystems 114 further includes the voice cloning subsystem 218 that is communicatively connected to the one or more hardware processors 110. The voice cloning subsystem 218 is configured to replicate one or more voice based inputs, thereby enhancing the personalization of the generated content. The voice cloning subsystem 218 is initially configured to collect the one or more voice based inputs from the one or more electronic devices 106 associated with the one or more users, thereby capturing the distinctive vocal characteristics unique to each user of the one or more users. In another exemplary embodiment, the voice cloning subsystem 218 is further configured to transmit the one or more voice based inputs to a speech-to-text AI model. This allows the system 102 to convert the one or more voice based inputs into the textual data for further processing and analysis. Subsequently, the voice cloning subsystem 218 is configured to determine the optimized voice cloning based artificial intelligence model of the one or more voice cloning based artificial intelligence models, thereby ensuring that one or more cloned voices closely match to the one or more voice based inputs associated with the one or more users. This selection process is crucial for achieving an accurate replication of the one or more voice based inputs, ensuring authenticity in the generated content.

The voice cloning subsystem 218 is further configured to extract specific traits that may comprise, but not limited to, at least one of: emotions, accents, and the like associated with the one or more voice based inputs by employing the optimized voice cloning based artificial intelligence model. The voice cloning subsystem 218 is further configured to integrate the extracted specific traits into a base speech model, enabling the system 102 to imbue the one or more cloned voices with the same emotional nuances and accents as the original one or more voice based inputs.

By applying one or more speech artifacts with the base speech model, the voice cloning subsystem 218 is configured to generate the one or more cloned voices that closely mirror the one or more voices associated with the one or more users, achieving a high level of fidelity and authenticity in the generated content. The one or more speech artifacts may include factors such as intonation, pitch modulation, rhythm, cadence, and the like. By applying the one or more speech artifacts involves manipulating the factors within the base speech model to accurately replicate unique vocal qualities of the one or more voice based inputs. This meticulous process ensures that the one or more cloned voices of the generated one or more memoir events resonates authentically with the one or more users, enhancing an engagement and a connection with the personalized content.

In an exemplary embodiment, the event generation subsystem 214 extends its functionalities to cater to life events and experiences of the one or more users. Firstly, the event generation subsystem 214 acquires the one or more inputs from the one or more electronic devices 106 associated with the one or more users. The one or more inputs encompasses one or more events that have transpired throughout the life and the experiences associated with the one or more users. Subsequently, leveraging the AI model trained on the one or more data sources, the event generation subsystem 214 retrieves relevant information associated with the one or more events. This training process enables the AI model to effectively recognize and extract the pertinent information associated with the one or more events occurred during the life and the experiences.

Finally, the event generation subsystem 214 provides the curated information back to the one or more electronic devices 106, facilitating a user interaction and enabling the one or more users to select and adapt the retrieved information associated with the one or more events. By providing the one or more users with access to the personalized and relevant event-related information, the system 102 enhances user engagement and enables the one or more users to reflect on and commemorate significant moments in their lives.

The plurality of subsystems 114 further comprises the event optimizing subsystem 220 that is communicatively connected to the one or more processors 110. The event optimizing subsystem 220 is configured to enhance the personalization and emotional resonance of the generated one or more memoir events. Firstly, the event optimizing subsystem 220 is configured to acquire one or more multi-media contents. The one or more multi-media contents may comprise, but not limited to, at least one of: one or more videos, one or more images, one or more audios, and the like from the one or more electronic devices 106. The one or more multi-media contents encapsulates various aspects of the life and the experiences of the one or more users, thereby providing rich visual and auditory material for analysis. Next, the event optimizing subsystem 220 is further configured to analyze the one or more multi-media content, thereby extracting one or more emotional parameters associated with the one or more users. The one or more emotional parameters may comprise, but not limited to, at least one of: sentiment, happy, sad, and the like reflecting emotional states of the one or more users and the experiences depicted in the one or more multi-media contents.

Following the analysis, the event optimizing subsystem 220 is further configured to integrate the one or more emotional parameters into the generated one or more memoir events, thereby optimizing the emotional depth and resonance of the content. This integration of the one or more emotional parameters enriches the storytelling aspect of the one or more memoir events, making the one or more memoir events more compelling and resonant for the one or more users.

The plurality of subsystems 114 further comprises the virtual reality subsystem 222 that is communicatively connected to the one or more hardware processors 110. The virtual reality subsystem 222 is configured to elevate the immersive experience of the one or more memoir events for the one or more users. The virtual reality subsystem 222 is configured to integrate the one or more cloned voices with the one or more cloned images of the one or more users, thereby creating a virtual reality where the one or more cloned images visually depicts the one or more users while the one or more cloned voices audibly narrate the one or more memoir events.

By employing one or more virtual reality based technologies, the virtual reality subsystem 222 is configured to orchestrate a seamless fusion of the one or more cloned voices and the one or more cloned images. This immersive presentation enables the one or more users to witness their virtual counterparts embodying their personas, effectively bringing the one or more memoir events to the life in a visually captivating and emotionally engaging manner. Herein in an exemplary embodiment, the one or more virtual reality based technologies may comprise, but not limited to, deep fake technologies.

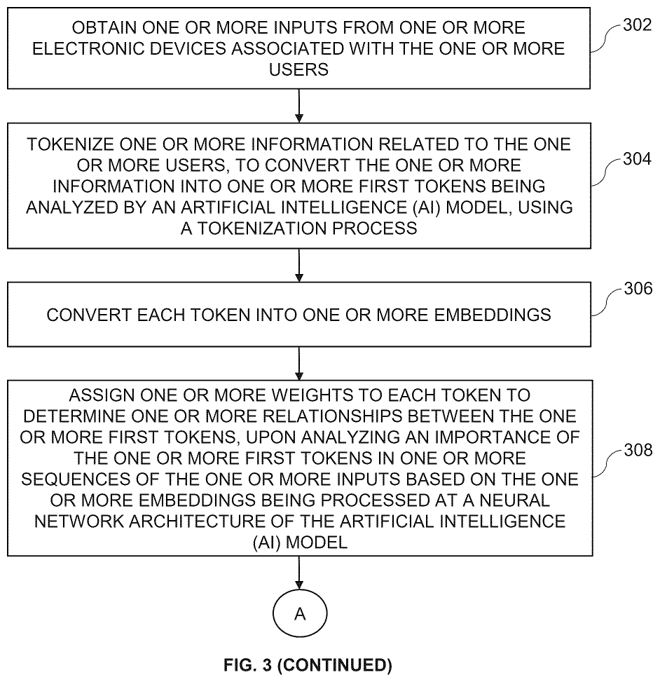

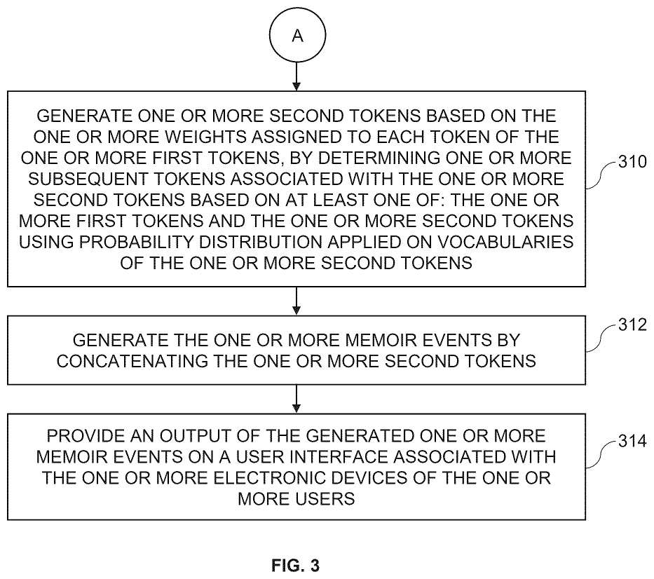

FIG. 3 illustrates an flow chart depicting an AI-based event generation method 300 for generating the one or more memoir events based on the one or more information associated with the one or more users, in accordance with an embodiment of the present disclosure.

In accordance with an embodiment of the present disclosure, the AI-based event generation method 300 (hereinafter referred to as the method 300) for generating the one or more memoir events based on the one or more information associated with the one or more users is disclosed.

At step 302 of the method 300, the one or more hardware processors 110 acquires the one or more inputs from the one or more electronic devices 106 linked to the one or more users. The one or more inputs encompasses the one or more information pertinent to the one or more users. The one or more information is associated with, but not limited to, at least one of the: the one or more prompts, the life and experiences, and the like, associated with the one or more users. The one or more information serves as the foundational material for crafting the one or more personalized memoir events, capturing the essence of narratives of the one or more users and facilitating the generation of meaningful and engaging content.

At step 304, the method 300 proceeds with tokenization by the one or more hardware processors 110. The one or more information associated with the one or more users is segmented into discrete units known as the one or more first tokens. The tokenization process facilitates analysis by the AI model, allowing for a structured approach to understanding and processing the one or more inputs. The one or more first tokens may comprise, but not limited to, at least one of: the one or more words, the one or more sub-words, the one or more characters, and the like, based on the tokenization process.

At step 306, the method 300 involves the conversion of each first token into the one or more embeddings by the one or more hardware processors 110. The one or more embeddings are the one or more numerical representations that encapsulate the semantic information and the syntactic information associated with the respective one or more first tokens. By transforming the one or more first tokens into the one or more embeddings, the method 300 enhances the interpretability and computational efficiency of the one or more inputs, thereby enabling the AI model to effectively analyze and process the underlying one or more information.

At step 308, the method 300 proceeds by assigning the one or more weights to each token. This weight assignment is performed by the one or more hardware processors 110. This assignment aims to ascertain relationships among the one or more first tokens by analyzing their importance within the one or more sequences of the one or more inputs based on the one or more embeddings being processed at the neural network architecture of the AI model. Leveraging the neural network architecture embedded within the AI model, the method 300 evaluates the significance of the one or more first tokens.

At step 310, in the method 300 the one or more assigned weights to each token is employed to guide the generation of the one or more second tokens. Employing the probabilistic technique, the method 300 selects the one or more subsequent tokens associated with the one or more second tokens based on at least one of: the one or more first tokens and the one or more second tokens. This iterative process continues until the AI model achieves the predetermined optimal length of the one or more sequences of the one or more second tokens, ensuring coherence and completeness in the generated content.

By leveraging the probability distribution derived from the one or more weights and the vocabularies, the method 300 effectively constructs the meaningful one or more sequences of the one or more second tokens. As a result, the AI model produces the comprehensive and engaging one or more memoir events that capture the essence of the experiences and the one or more prompts of the one or more users, contributing to the more personalized and immersive user experience.

At step 312, the method 300 proceeds to construct the actual one or more memoir events using the generated one or more second tokens. Through concatenation, the method 300 combines the one or more second tokens in a sequential manner to form coherent and meaningful narratives. The method 300 ensures that the events generated maintain logical flow and cohesion, effectively encapsulating the essence of the experiences and the one or more prompts of the one or more users.

At step 314, the method 300 proceeds to deliver the output to the one or more users via the user interface associated with the one or more electronic devices 106. This step ensures the seamless interaction and accessibility for the one or more users, allowing the one or more users to engage with the generated content conveniently. This final step completes the method 300, enabling the one or more users to explore and reflect on the generated one or more memoir events at convenience.

Numerous advantages of the present disclosure may be apparent from the discussion above. In accordance with the present disclosure, the method 300 for generating the one or more memoir events based on the one or more information associated with the one or more users is disclosed. The system 102 is configured to automatically edit and correct the one or more inputs received from the one or more users on the fly for grammar, sentence, paragraph structure, style, and the like to ensure the one or more inputs is always perfect for the one or more memoir events. The system 102 is configured to suggest one or more responses for some topics/questions, so the one or more users don't have to remember details like dates and events. The system 102 is further configured to provide an option to either engage in a structured interview process to craft the one or more memoir events or freely discuss any topic the one or more users may desire.

Both approaches are seamlessly integrated into the one or more memoir events, ensuring a comprehensive reflection of the experiences and thoughts of the one or more users. The system 102 is configured with a “quick-record” feature where the one or more users start talking about whatever topic of their choice. The system 102 is configured to suggest a topic name based on what the one or more users talks about. This information is included in creating the one or more memoir events. Henceforth, the system 102 becomes a lifelong companion documenting the life of the one or more users.

The system 102 is configured to further update stories of the one or more users, ensuring the stories reflect the latest experiences of the one or more users and making the one or more memoir events a living document. The system 102 is further configured to provide the option to easily share the one or more memoir events with loved ones, thereby strengthening familial bonds and preserving a legacy of the one or more users for future generations.

The system 102 is configured to provide a platform for people with shared experiences to connect. The system 102 is further configured to provide the ability to interact with professional human biographers for further customization of the one or more memoir events. The system 102 is further configured create a knowledge base of the one or more memoir events shared with the one or more users by loved ones and includes the one or more memoir events of the one or more users. Using this, the system 102 is further configured create the AI model that counsels when the one or more users need advice through the life. When the one or more users initially sign up in the system 102, the system 102 is configured to perform an exhaustive search and collects all information from publicly available sources regarding the one or more users for creating the one or more memoir events.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence based (AI-based) event generation method for generating one or more memoir events based on one or more information associated with one or more users, the artificial intelligence based (AI-based) event generation method comprising:
obtaining, by one or more hardware processors, one or more inputs from one or more electronic devices associated with the one or more users, wherein the one or more inputs comprise the one or more information related to the one or more users, and wherein the one or more information is associated with at least one of: one or more prompts, and life and experiences associated with the one or more users;
tokenizing, by the one or more hardware processors, the one or more information related to the one or more users, to convert the one or more information into one or more first tokens being analyzed by an artificial intelligence (AI) model, using a tokenization process, wherein the one or more first tokens comprise at least one of: one or more words, one or more sub-words, and one or more characters, based on the tokenization process;
converting, by the one or more hardware processors, each token into one or more embeddings, wherein the one or more embeddings are one or more numerical representations comprising at least one of: one or more semantic and syntactic information associated with the one or more first tokens;
assigning, by the one or more hardware processors, one or more weights to each token to determine one or more relationships between the one or more first tokens, upon analyzing an importance of the one or more first tokens in one or more sequences of the one or more inputs based on the one or more embeddings being processed at a neural network architecture of the artificial intelligence (AI) model;
generating, by the one or more hardware processors, one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens,
wherein the one or more second tokens are generated until the artificial intelligence (AI) model generates a predetermined optimum length of one or more sequences of the one or more second tokens;
generating, by the one or more hardware processors, the one or more memoir events by concatenating the one or more second tokens; and
providing, by the one or more hardware processors, an output of the generated one or more memoir events on a user interface associated with the one or more electronic devices of the one or more users.

2. The artificial intelligence based (AI-based) event generation method of claim 1, further comprising training, by the one or more hardware processors, the artificial intelligence (AI) model, by:
obtaining, by the one or more hardware processors, one or more data from one or more data sources comprising at least one of: one or more books, one or more articles, and one or more websites;
tokenizing, by the one or more hardware processors, one or more data to convert the one or more data into one or more third tokens, wherein the one or more third tokens comprise the one or more words, one or more parts of words, and one or more individual characters;
training, by the one or more hardware processors, the artificial intelligence (AI) model on the obtained one or more data using a supervised learning algorithm, wherein training the artificial intelligence (AI) model comprises learning of the artificial intelligence (AI) model to at least one of: determine at least one of: the one or more second tokens in the one or more sequences and provide missing one or more second tokens in the one or more sequences;
fine-tuning, by the one or more hardware processors, the trained artificial intelligence (AI) model on one or more task-specific datasets to optimize performance of the artificial intelligence (AI) model on one or more applications; and
evaluating, by the one or more hardware processors, the trained artificial intelligence (AI) model to assess capabilities of the artificial intelligence (AI) model in analyzing and generation of the one or more memoir events.

3. The artificial intelligence based (AI-based) event generation method of claim 2, wherein the trained artificial intelligence (AI) model on the one or more task-specific datasets is fine-tuned using at least one of: beam search and reinforcement learning, based on a feedback on the performance of the artificial intelligence (AI) model.

4. The artificial intelligence based (AI-based) event generation method of claim 1, further comprising:
obtaining, by the one or more hardware processors, one or more voice based inputs from the one or more electronic devices associated with the one or more users;
determining, by the one or more hardware processors, an optimized voice cloning based artificial intelligence model among one or more voice cloning based artificial intelligence models upon analyzing one or more cloned voices being identical to one or more voices associated with the one or more users;
extracting, by the one or more hardware processors, at least one of: emotions and accents, associated with the one or more voice based inputs of the one or more users, using the optimized voice cloning based artificial intelligence model;
applying, by the one or more hardware processors, at least one of: the emotions and accents into a base speech model; and
generating, by the one or more hardware processors, the one or more cloned voices being identical to one or more voices associated with the one or more users by applying one or more speech artifacts with the base speech model.

5. The artificial intelligence based (AI-based) event generation method of claim 1, further comprising:
obtaining, by the one or more hardware processors, the one or more inputs from the one or more electronic devices associated with the one or more users, wherein the one or more inputs comprise one or more events occurred during the life and experiences associated with the one or more users;
retrieving, by the one or more hardware processors, information associated with the one or more events occurred during the life and experiences based on training of the artificial intelligence (AI) model on the one or more data sources; and
providing, by the one or more hardware processors, the information associated with the one or more events occurred during the life and experiences, to the one or more electronic devices associated with the one or more users to adapt the one or more users to select the information associated with the one or more events.

6. The artificial intelligence based (AI-based) event generation method of claim 1, further comprising:
obtaining, by the one or more hardware processors, one or more multi-media contents comprising one or more videos, one or more images, one or more audios, associated with the life and experiences of the one or more users, from the one or more electronic devices associated with the one or more users;
analyzing, by the one or more hardware processors, the one or more multi-media contents to extract one or more emotional parameters associated with the one or more users, wherein the one or more emotional parameters comprise at least one of: sentiment, happy, and sad, associated with the one or more users; and
integrating, by the one or more hardware processors, the one or more emotional parameters associated with the one or more users, into the one or more memoir events to optimize the one or more memoir events.

7. The artificial intelligence based (AI-based) event generation method of claim 4, further comprising combining, by the one or more hardware processors, the one or more cloned voices with one or more cloned images of the one or more users to generate a virtual reality displaying that the one or more cloned images of the one or more users read the one or more memoir events in the one or more cloned voices of the one or more users, using one or more virtual reality based technologies.

8. An artificial intelligence based (AI-based) event generation system for generating one or more memoir events based on one or more information associated with one or more users, the artificial intelligence based (AI-based) event generation system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input obtaining subsystem configured to receive one or more inputs from one or more electronic devices associated with the one or more users, wherein the one or more inputs comprise the one or more information related to the one or more users, and wherein the one or more information is associated with at least one of: one or more prompts, and life and experiences associated with the one or more users;
a token generation subsystem configured to tokenize the one or more information related to the one or more users, to convert the one or more information into one or more first tokens being analyzed by an artificial intelligence (AI) model, using a tokenization process, wherein the one or more first tokens comprise at least one of: one or more words, one or more sub-words, and one or more characters, based on the tokenization process;
an embedding conversion subsystem configured to convert each token into one or more embeddings, wherein the one or more embeddings are one or more numerical representations comprising at least one of: one or more semantic and syntactic information associated with the one or more first tokens;
a weight assigning subsystem configured to assign one or more weights to each token to determine one or more relationships between the one or more first tokens, upon analyzing an importance of the one or more first tokens in one or more sequences of the one or more inputs based on the one or more embeddings being processed at a neural network architecture of the artificial intelligence (AI) model;
the token generation subsystem further configured to generate one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens,
wherein the one or more second tokens are generated until the artificial intelligence (AI) model generates a predetermined optimum length of one or more sequences of the one or more second tokens;
an event generation subsystem configured to generate the one or more memoir events by concatenating the one or more second tokens; and
an output subsystem configured to provide an output of the generated one or more memoir events on a user interface associated with the one or more electronic devices of the one or more users.

9. The artificial intelligence based (AI-based) event generation system of claim 8, further comprising a training subsystem configured to train the artificial intelligence (AI) model, wherein in training the artificial intelligence (AI) model, the training subsystem is configured to:
obtain one or more data from one or more data sources comprising at least one of: one or more books, one or more articles, and one or more websites;
tokenize one or more data to convert the one or more data into one or more third tokens, wherein the one or more third tokens comprise the one or more words, one or more parts of words, and one or more individual characters;
train the artificial intelligence (AI) model on the obtained one or more data using a supervised learning algorithm, wherein training the artificial intelligence (AI) model comprises learning of the artificial intelligence (AI) model to at least one of: determine at least one of: the one or more second tokens in the one or more sequences and provide missing one or more second tokens in the one or more sequences;
fine-tune the trained artificial intelligence (AI) model on one or more task-specific datasets to optimize performance of the artificial intelligence (AI) model on one or more applications; and
evaluate the trained artificial intelligence (AI) model to assess capabilities of the artificial intelligence (AI) model in analyzing and generation of the one or more memoir events.

10. The artificial intelligence based (AI-based) event generation system of claim 9, wherein the training subsystem is configured to fine-tune the trained artificial intelligence (AI) model on the one or more task-specific datasets, using at least one of: beam search and reinforcement learning, based on a feedback on the performance of the artificial intelligence (AI) model.

11. The artificial intelligence based (AI-based) event generation system of claim 8, further comprising a voice cloning subsystem configured to:
obtain one or more voice based inputs from the one or more electronic devices associated with the one or more users;
determine an optimized voice cloning based artificial intelligence model among one or more voice cloning based artificial intelligence models upon analyzing one or more cloned voices being identical to one or more voices associated with the one or more users;
extract at least one of: emotions and accents, associated with the one or more voice based inputs of the one or more users, using the optimized voice cloning based artificial intelligence model;
apply at least one of: the emotions and accents into a base speech model; and
generate one or more cloned voices being identical to one or more voices associated with the one or more users by applying one or more speech artifacts with the base speech model.

12. The artificial intelligence based (AI-based) event generation system of claim 8, wherein the event generation subsystem is further configured to:
obtain the one or more inputs from the one or more electronic devices associated with the one or more users, wherein the one or more inputs comprise one or more events occurred during the life and experiences associated with the one or more users;
retrieve information associated with the one or more events occurred during the life and experiences based on training of the artificial intelligence (AI) model on the one or more data sources; and
provide the information associated with the one or more events occurred during the life and experiences, to the one or more electronic devices associated with the one or more users to adapt the one or more users to select the information associated with the one or more events.

13. The artificial intelligence based (AI-based) event generation system of claim 8, further comprising an event optimizing subsystem configured to:
obtain one or more multi-media contents comprising one or more videos, one or more images, one or more audios, associated with the life and experiences of the one or more users, from the one or more electronic devices associated with the one or more users;
analyze the one or more multi-media contents to extract one or more emotional parameters associated with the one or more users, wherein the one or more emotional parameters comprise at least one of: sentiment, happy, and sad, associated with the one or more users; and
integrate the one or more emotional parameters associated with the one or more users, into the one or more memoir events to optimize the one or more memoir events.

14. The artificial intelligence based (AI-based) event generation system of claim 11, further comprising a virtual reality subsystem configured to combine the one or more cloned voices with one or more cloned images of the one or more users to generate a virtual reality displaying that the one or more cloned images of the one or more users read the one or more memoir events in the one or more cloned voices of the one or more users, using one or more virtual reality based technologies.

15. A non-transitory computer-readable storage medium having instructions stored therein that when executed by one or more hardware processors, cause the one or more hardware processors to execute operations of:
obtaining one or more inputs from one or more electronic devices associated with the one or more users, wherein the one or more inputs comprise the one or more information related to the one or more users, and wherein the one or more information is associated with at least one of: one or more prompts, and life and experiences associated with the one or more users;
tokenizing the one or more information related to the one or more users, to convert the one or more information into one or more first tokens being analyzed by an artificial intelligence (AI) model, using a tokenization process, wherein the one or more first tokens comprise at least one of: one or more words, one or more sub-words, and one or more characters, based on the tokenization process;
converting each token into one or more embeddings, wherein the one or more embeddings are one or more numerical representations comprising at least one of: one or more semantic and syntactic information associated with the one or more first tokens;
assigning one or more weights to each token to determine one or more relationships between the one or more first tokens, upon analyzing an importance of the one or more first tokens in one or more sequences of the one or more inputs based on the one or more embeddings being processed at a neural network architecture of the artificial intelligence (AI) model;
generating one or more second tokens based on the one or more weights assigned to each token of the one or more first tokens, by determining one or more subsequent tokens associated with the one or more second tokens based on at least one of: the one or more first tokens and the one or more second tokens using probability distribution applied on vocabularies of the one or more second tokens,
wherein the one or more second tokens are generated until the artificial intelligence (AI) model generates a predetermined optimum length of one or more sequences of the one or more second tokens;
generating the one or more memoir events by concatenating the one or more second tokens; and
providing an output of the generated one or more memoir events on a user interface associated with the one or more electronic devices of the one or more users.

16. The non-transitory computer-readable storage medium of claim 15, further comprising training, by the one or more hardware processors, the artificial intelligence (AI) model, by:
obtaining one or more data from one or more data sources comprising at least one of: one or more books, one or more articles, and one or more websites;
tokenizing one or more data to convert the one or more data into one or more third tokens, wherein the one or more third tokens comprise the one or more words, one or more parts of words, and one or more individual characters;
training the artificial intelligence (AI) model on the obtained one or more data using a supervised learning algorithm, wherein training the artificial intelligence (AI) model comprises learning of the artificial intelligence (AI) model to at least one of: determine at least one of: the one or more second tokens in the one or more sequences and provide missing one or more second tokens in the one or more sequences;
fine-tuning the trained artificial intelligence (AI) model on one or more task-specific datasets to optimize performance of the artificial intelligence (AI) model on one or more applications; and
evaluating the trained artificial intelligence (AI) model to assess capabilities of the artificial intelligence (AI) model in analyzing and generation of the one or more memoir events.

17. The non-transitory computer-readable storage medium of claim 15, further comprising:
obtaining one or more voice based inputs from the one or more electronic devices associated with the one or more users;
determining an optimized voice cloning based artificial intelligence model among one or more voice cloning based artificial intelligence models upon analyzing one or more cloned voices being identical to one or more voices associated with the one or more users;
extracting at least one of: emotions and accents, associated with the one or more voice based inputs of the one or more users, using the optimized voice cloning based artificial intelligence model;
applying at least one of: the emotions and accents into a base speech model; and
generating one or more cloned voices being identical to one or more voices associated with the one or more users by applying one or more speech artifacts with the base speech model.

18. The non-transitory computer-readable storage medium of claim 15, further comprising:
obtaining the one or more inputs from the one or more electronic devices associated with the one or more users, wherein the one or more inputs comprise one or more events occurred during the life and experiences associated with the one or more users;
retrieving information associated with the one or more events occurred during the life and experiences based on training of the artificial intelligence (AI) model on the one or more data sources; and
providing the information associated with the one or more events occurred during the life and experiences, to the one or more electronic devices associated with the one or more users to adapt the one or more users to select the information associated with the one or more events.

19. The non-transitory computer-readable storage medium of claim 15, further comprising:
obtaining one or more multi-media contents comprising one or more videos, one or more images, one or more audios, associated with the life and experiences of the one or more users, from the one or more electronic devices associated with the one or more users;
analyzing the one or more multi-media contents to extract one or more emotional parameters associated with the one or more users, wherein the one or more emotional parameters comprise at least one of: sentiment, happy, and sad, associated with the one or more users; and
integrating the one or more emotional parameters associated with the one or more users, into the one or more memoir events to optimize the one or more memoir events.

20. The non-transitory computer-readable storage medium of claim 17, further comprising combining the one or more cloned voices with one or more cloned images of the one or more users to generate a virtual reality displaying that the one or more cloned images of the one or more users read the one or more memoir events in the one or more cloned voices of the one or more users, using one or more virtual reality based technologies.
